(19) United States
(12) Patent Application Publication
(10) Pub. No.: US 2010/0314139 A1
(43) Pub. Date: Dec. 16, 2010

(54) Target-Specific Fire Fighting Device For Launching A Liquid Charge At A Fire

(76) Inventors: Stephen C. Jacobsen, Salt Lake City, UT (US); Marc X. Olivier, Salt Lake City, UT (US); Ralph W. Pensel, Sandy, UT (US); Fraser M. Smith, Salt Lake City, UT (US)

Correspondence Address: THORPE, NORTH & WESTERN, LLP, P.O BOX 1219, SANDY, UT, 84091-1219, US

(21) Appl. No.: 12/814,435

(22) Filed: Jun. 11, 2010

Related U.S. Application Data
(60) Provisional application No. 61/186,306, filed on Jun. 11, 2009.

(51) Int. Cl. A62C 3/00

(52) U.S. Cl. 169/46; 169/54

(57) ABSTRACT

The present invention relates to a single-target-specific fire fighting device for launching a liquid charge towards a localized target portion of a fire. The firefighting device is capable of highly precise target engagement at a single, localized area. In this manner, the fire fighting device can launch a single liquid charge effectively to a target location within a fire, such as the seat of a fire, in order to effectively extinguish the fire. The firefighting device includes at least a liquid charge having a flight integrity component, a barrel, a sighting structure coupled to the barrel, and a launching system for launching the liquid charge down the barrel at a target location.

### RELATED APPLICATIONS

This application claims the benefit of U.S. Provisional Patent Application Ser. No. 61/186,306, filed Jun. 11, 2009, and entitled, “Target Specific Fire Fighting Device for Launching a Liquid Charge at a Fire,” which is incorporated by reference in its entirety herein.

### FIELD OF THE INVENTION

The present invention relates to generally to methods and systems for fighting fires. More particularly, the present invention relates to liquid projectiles capable of being launched from a launching device towards or into a fire for purposes of fire suppression.

### BACKGROUND OF THE INVENTION AND RELATED ART

Modern fire fighting techniques have dramatically aided to reduce the average damage caused by both urban and open land fires. Not withstanding the technological advances and improved techniques, fires currently claim thousands of lives each year and results in billions of dollars in direct property losses in the United States alone. While fire fighting efficiency is continually improving, there remains a need for more precise and effective fire fighting tools and techniques.

Fires require at least three elements for initial combustion: combustible matter, such as paper, wood, gasoline, oil, etc; a combustive agent or oxidant, usually oxygen from the air; and activation energy, such as heat, a spark, etc. To extinguish a fire it is necessary to remove at least the fuel or the combustive agent. It is also necessary to reduce the temperature of the surrounding environment in order to prevent a fire from reigniting.

Not all fires are the same. An open range grass fire will be fought differently than a forest fire or a closed volume fire, such as a fire within a building or house. Furthermore, oil and chemical fires will be fought using different techniques and materials than forest fires. Many chemical fires cannot be extinguished by water, but require specific fire retardants to extinguish the blaze. In order to suppress the wide variety of fires, firefighting techniques require an analysis of the fire, its origins, its hot spots, its potential for damage, etc.

In closed volume fires, a direct spray to the fire seat can have negative consequences: the water can push air in front of it, further feeding the fire and mixing the gases in the closed volume. This activation of the fire and the mixing of gases produced by the liquid flow can cause a flashover, which occurs when the majority of all combustible material in an enclosed space simultaneously ignites. To prevent a flashover in closed volume fires, it can be advantageous to first cool the smoke within an enclosed space, in order to prevent the smoke from spreading and starting distant fires.

High rise structures pose another challenge to closed volume fires ignited within these buildings. Due to the extreme height of high rise structures it can be difficult for fire fighters to get water to a fire on a high floor due to lack of water pressure. Often, any height over 50 meters can be out of reach. Even when a high floor can be reached by water, the water stream can break up to such an extent that the direction and quantity of the water can be hard to control.

Forest fires likewise pose a variety of challenges to fire fighters. Currently, forest fires are attacked by dropping fire suppressant or retardant on or in front of an existing fire by aerial tankers, which include both planes and helicopters. When a fire suppressant, also known as the air drop, is dropped a large portion of the air drop can turn into vapor before it reaches the seat of the fire. In open air fires, vapor can diffuse away from the target fires, producing little effect on the blaze. In order to decrease break-up and evaporation and make an accurate drop, aerial tankers are often flown dangerously low, and are forced to maneuver with great caution and skill.

### SUMMARY

The present invention is directed to an apparatus that satisfies this need. A single-target-specific fire fighting device of the present invention, herein referred to as a fire fighting device, is capable of highly precise targeting and target engagement at a single localized area within a targeted fire, the projected liquid charge having increased flight integrity. A fire fighting device of the present invention comprises a barrel having a chamber at one end for directing a projected liquid charge at a target location. A sighting structure can be coupled to the barrel. A liquid charge can be launched down the barrel by a launching system, wherein the liquid charge has a flight integrity component to help the liquid charge inhibit substantial break-up during flight.

The flight integrity component can increase the cohesive properties of a liquid or liquid charge, and thus enable the liquid charge to be projected further distances and at higher elevations, while substantially maintaining its volume. Alternatively, a flight integrity component can comprise a non-rigid encapsulation, which can provide a supporting structure to a liquid charge contained therein, enabling it to substantially retain its volume. A flight integrity component can also have a disruption apparatus that can disrupt the flight integrity component and diffuse the liquid charge.

As an alternative to water, various other liquids, or liquids combined with various fire retardants can be enclosed and projected in a non-rigid encapsulation. A plurality of fire retardants can be incorporated into the invention to assist in the suppression of various types of fires. Typically fire retardants are broadly classified as types A, B, or C and are used on fires of different fuel sources. The present invention is designed to incorporate the use of each type of fire retardant.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a perspective view of two fire fighting devices in accordance with two aspects of the present invention;

FIG. 2 is a perspective view of a non-rigid encapsulation rolled from one end onto itself in accordance with an aspect of the present invention;

FIG. 3 is a perspective view of a non-rigid encapsulation filled with a liquid in accordance with an aspect of the present invention;

FIG. 4 is a cross-sectional view of a fire fighting device in accordance with an aspect of the present invention;

FIG. 5 is a cross-sectional view of another fire fighting device in accordance with another aspect of the present invention;

FIG. 6 is a cross-sectional view of another fire fighting device in accordance with yet another aspect of the present invention; and

FIG. 7 is a flow chart of a method of utilizing a fire fighting device in accordance with an aspect of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXEMPLARY EMBODIMENTS

The following detailed description makes reference to the accompanying drawings, which form a part thereof and in which are shown, by way of illustration, various representative embodiments in which the invention can be practiced. While these embodiments are described in sufficient detail to enable those skilled in the art to practice the invention, it should be understood that other embodiments can be realized and that various changes can be made without departing from the spirit and scope of the present invention. As such, the following detailed description is not intended to limit the scope of the invention as it is claimed, but rather is presented for purposes of illustration, to describe the features and characteristics of the representative embodiments, and to sufficiently enable one skilled in the art to practice the invention. Accordingly, the scope of the present invention is to be defined solely by the appended claims.

Furthermore, the following detailed description and representative embodiments of the invention will best understood with reference to the accompanying drawings, wherein the elements and features of the embodiments are designated by numerals throughout.

In describing and claiming the present invention, the following terminology will be used.

The singular forms “a,” “an,” and “the” include plural referents unless the context clearly dictates otherwise. Thus, for example, reference to “a barrel” includes reference to one or more of such barrels, and reference to “an additive” includes reference to one or more of such additive.

As used herein, “flight integrity component” refers to a component that when combined with a liquid charge can inhibit substantial break-up of the liquid charge during flight. Typically, a flight integrity component can be an additive or a non-rigid encapsulation. Combining this component with a liquid charge can substantially inhibit spray and separation of the liquid charge when launched.

As used herein, “additive” refers to any liquid, gas, or solid, that can be combined with a liquid charge to modify at least one physical property of the liquid charge.

As used herein, “liquid charge” refers to any defined quantity of any type of liquid or liquid combined with an additive. As such, a defined quantity of water, salt water, or liquid nitrogen can form a liquid charge.

As used herein, “trajectory” refers to any flight path in a direct direction other than in the direction of the force of gravity. For example, trajectory may refer to a path of flight that a liquid charge projected from a moving aerial tanker will take given the various environmental conditions. Alternatively, a trajectory does not include the path of a liquid charge that has been dropped from a moving or static aerial tanker.

As used herein, “charge modification component” refers to a component that combines a liquid charge with an additive. As such a charge modification component can include any component that has combinational capabilities for a specific additive and a specific liquid charge, or for a component that has combinational capabilities for a broad range of additives and a broad range of liquid charges. For example, a charge modification device can combine an additive with a liquid by mixing, heating, cooling, sequentially combining chemicals, and similar means as will be practical with the invention, and combinations thereof.

As used herein, “single-target-specific fire fighting device” refers to a fire fighting device configured to fire or launch a single projectile or a succession of projectiles accurately at a target location.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 gallon to about 5 gallons” should be interpreted to include not only the explicitly recited values of about 1 gallon to about 5 gallons, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value and should apply regardless of the breadth of the range or the characteristics being described.

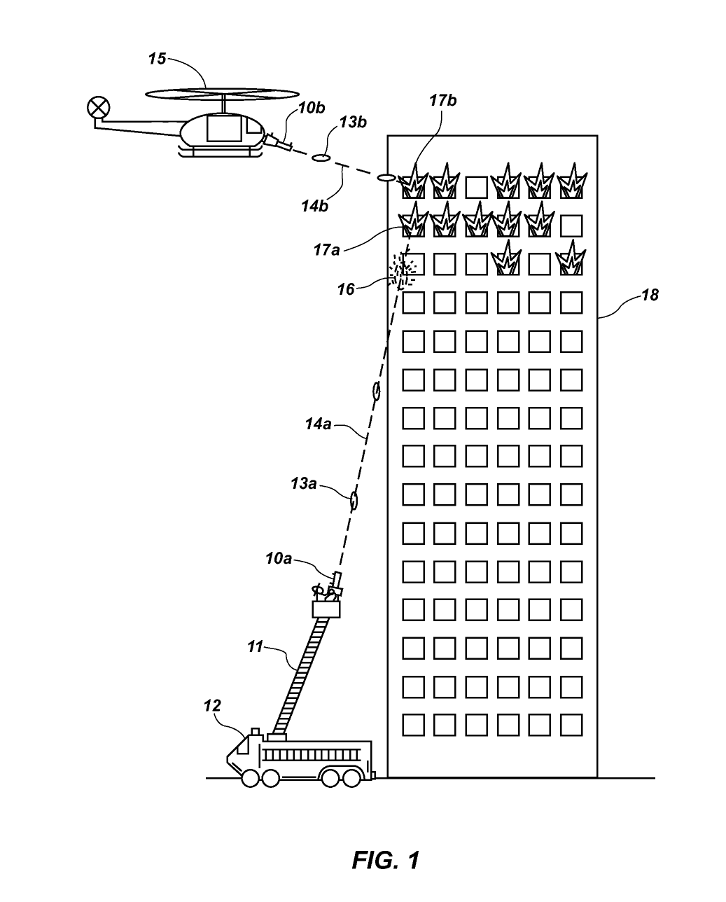

As illustrated in FIG. 1, a fire fighting device 10a in accordance with one aspect of the invention can be mounted on an extendable ladder 11 of a fire truck 12, for projecting a first plurality of liquid charges 13a. This first fire fighting device can be configured to project a first plurality of liquid charges from an elevated position to a specific location of a fire 17a in the multi-story building 18, along a predefined trajectory 14a.

According to another aspect of the invention, a firefighting device 10b can be mounted on a helicopter 15. The fire fighting device can be configured to project a liquid charge or plurality of liquid charges 13b at a specific location 17b of the multi-story building 18 along a predefined trajectory 14b. Because the fire fighting device is capable of high precision target engagement, the helicopter can be flown at a safe distance, while not substantially compromising the effectiveness of the firefighting effort.

According to another aspect of the invention, a liquid charge 13a can have a disruption apparatus that diffuses the liquid charge into a spray 16. In various fire fighting techniques a spray of liquid or fire retardant can be preferred over a single liquid charge. A disrupting apparatus can be triggered from a variety of sources, such as radio frequencies, heat sensors, timing mechanisms, laser devices, and other suitable means.

According to another aspect of the invention, a liquid charge a can be launched directly from a fire fighting device mounted in a fixed position. Alternatively, the portable device can be mounted on a variety of vehicles, including but not limited to, an aircraft, a sea craft, or a civilian vehicle. Alternatively, a fire fighting device can be a portable device that can be transported, positioned, launched, and then removed, but which retains a desired position during use. A portable launcher can be a fire fighting device similar to a rocket launcher or a much larger fire fighting device, such as a towed carriage or trailer. Similarly, a portable launcher for projecting a liquid charge can be a small fire fighting device, similar to a small handheld pistol, which is configured to project liquid charges.

A liquid charge can be a liquid charge of a specified volume (e.g., a liter). For example, liquid projectiles may comprise liquid volumes ranging from 1 mL to 500 L of liquid. However, this range is not to be considered limiting as liquid projectiles can comprise any volume capable of being contained and launched.

Liquid projectiles include at least a liquid charge combined with a non-rigid flight integrity component. The non-rigid flight integrity component can modify the liquid charge and inhibit substantial break-up of the liquid charge in flight. The flight integrity component can be an additive, a non-rigid encapsulation, a temperature modification component, or other component. Combining the flight integrity component with a liquid charge can allow the liquid charge to be launched at higher speeds and further distances than a non-modified liquid charge.

Pure water has viscous properties which allow it to reasonably maintain its form when traveling at relatively low speeds or in small quantities, such as a falling raindrop. But, when water is projected at high speeds and in large quantities, such as water projected from a fire hose, the cohesive structure of the water stream can be disrupted by air resistance and the projection force, causing the resulting water stream to at least partially break apart into a spray after a certain distance. In order to launch water or other liquid charges at high speeds and far distances a flight integrity component can be combined with the water or other liquid to provide enhanced structure, viscosity, and/or cohesiveness. Typical liquids include: water, salt water, liquid fire retardants, and other liquids that will be practical to the invention.

Liquid modifying additives can also be combined with the liquid charge to inhibit substantial break-up of the liquid during flight. According to one aspect of the invention, a small quantity of polyethylene oxide (PEO), in some cases as small as 0.8% (w), can be added to a liquid, such as water, to increase the cohesive properties of the liquid. The resulting liquid charge will have less friction and drag than the liquid alone, thus reducing spray. When the resulting liquid charge is launched the friction from a fire fighting device barrel is reduced and the launched stream or charge can have greater cohesiveness, resulting in higher projection speeds, further trajectories, improved accuracy, and more effective impact with a target.

Similarly, polyacrylamide, polypropylene oxide, polydiamine, and other practical additives known in the art can be combined with a liquid to inhibit substantial break-up of the liquid during flight.

Additives can also be combined with a liquid to form shear-thickening fluids, also known as dilatant fluids, in order to inhibit substantial break-up of the liquid during flight. Shear-thickening fluids cause an increase in viscosity of the liquid charge with increasing shear stress which is most easily accomplished by increasing the rate of shear deformation. For example, a shear thickening fluid may offer little resistance to a gentle probe with one's finger, but can become increasingly viscous when one quickly thrusts a finger at the fluid. In this manner, a shear thickened liquid projectile can respond to a launching force with increased resistance, enabling the liquid projectile to be launched with more force. Upon impact this liquid projectile can increase its resistance to the stress of the impact, thus acting more like a solid projectile for more precise fire fighting capabilities, if needed.

Typical shear thickening additives can include: polyethylene glycol with nano-particles of silica, corn starch or modified corn starch, potato starch, pectin, xanthan gum, arrow root powder, dihydroxypropyl ethers of cellulose (as disclosed in U.S. Pat. No. 4,096,326), cellulose-free xanthan gum with a number of cellulose compounds, including carboxymethyl cellulose, hydroxyethyl cellulose and hydroxypropylmethyl cellulose (as disclosed in U.S. Pat. No. 4,313,765). Other examples include, sulfonated guar and a compound comprising at least one member selected from the group consisting of xanthan gum, guar, hydroxpropyl guar or derivatives, hydroxyethyl cellulose or derivatives. Further shear thickening additives may include, cationic guar and a compound comprising at least one member selected from the group of hydroxypropyl guar or derivatives and hydroxyethyl cellulose or derivatives (as disclosed in U.S. Pat. No. 4,524,003), hydroxypropyl cellulose with polymaleic and hydroxy derivatives (as disclosed in U.S. Pat. Nos. 4,169,818 and 4,172,055), or any combination as will be practical to the invention.

Additives can be combined by mixing, stirring, heating/cooling processes, injecting, reacting or applying, as well as combinations of these processes. Other combining methods that will be practical with the present invention are similarly contemplated in accordance with the invention.

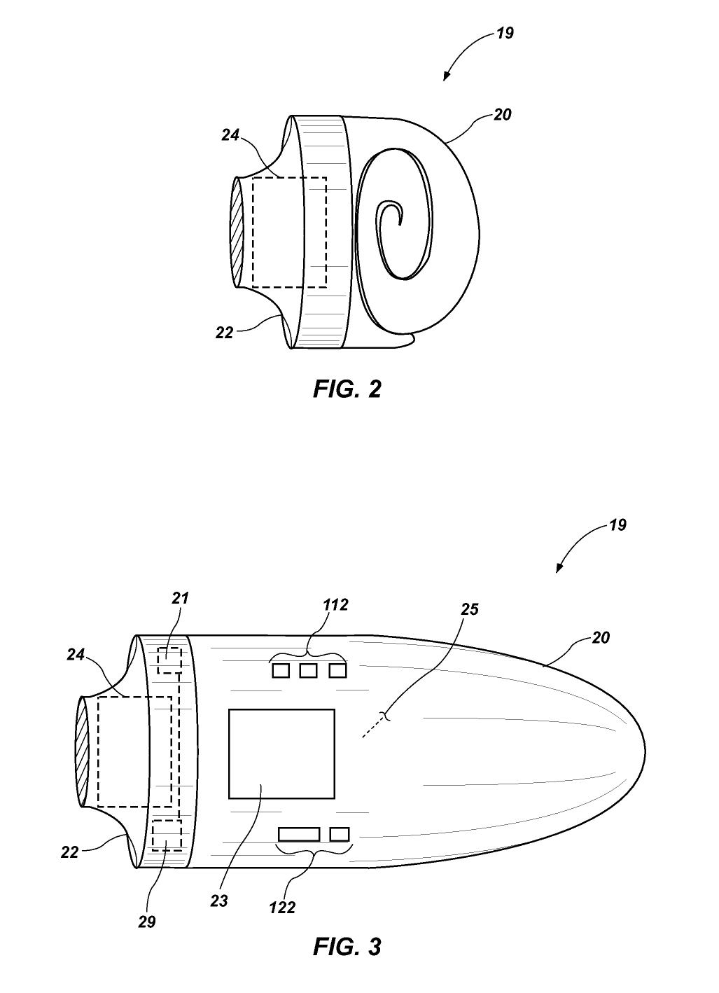

A flight integrity component (e.g., a non-rigid encapsulation or additive) filled or loaded with a liquid charge as described, combine to form a liquid projectile. FIG. 2 illustrates one exemplary embodiment of a flight integrity component in the form of a non-rigid encapsulation 19, herein referred to as an “encapsulation”, that can be implemented using a collapsible plastic encapsulation 20. According to one aspect of the invention the collapsible plastic encapsulation can be rolled from one end onto itself. This collapsible plastic encapsulation can be joined to a closing device 22 or it can be integrally formed with a closing device, or formed of the same piece of material. When the collapsible plastic encapsulation is rolled, it is compacted to a relatively small volume to facilitate storage and loading capabilities. When a rolled encapsulation is loaded into a fire fighting device, it can be easily unrolled with the pressures of the fluid filling the encapsulation. In other aspects of the invention, the empty plastic encapsulation can be folded, non-folded, compressed or stored in any fashion practical to the invention. The collapsible plastic encapsulation can be a non-elastic or elastic encapsulation. When elastic plastic is used the collapsible plastic encapsulation can further be left in a non-inflated, non-folded, or non-rolled position.

In one aspect of the invention, the encapsulation can be formed from a tube of flexible plastic, such as polyethylene. The flexible plastic can be filled with a liquid charge and sealed on a front and a rear end in order to enclose the liquid charge within the plastic. In this manner a plurality of liquid charges can be encapsulated and launched in rapid succession. The embodiments of an encapsulation and sealer device will be apparent to one of ordinary skill in the art.

The closing device 22 can be a device, such as a crimp, cap, seal, pressure seal, valve or a more complex closing device can also be used, which allows a non-rigid encapsulation to be rapidly filled with a liquid, rapidly sealed or enclosed, and launched. In another aspect of the invention, the closing device 22 and/or the non-rigid encapsulation can be formed of a non-combustible, biodegradable material. Alternatively, the closing device and non-rigid encapsulation can be integrally formed, or formed of the same piece of material.

As shown in FIG. 3, the non-rigid encapsulation 19 of FIG. 2 can be filled with a liquid charge 25. The shape of the filled encapsulation can vary based on the shape of the collapsible plastic encapsulation 20. The diameter of the encapsulation can be approximately the diameter of the barrel of the launching device to create launch pressure behind the encapsulation and to provide a launching force. To provide increased trajectory and accuracy, the encapsulation can be aerodynamically shaped, as will be apparent to one skilled in the art. This shape can subsequently modify the shape of the closing device 22.

A propellant device 24 can be included in the closing device 22. The device can enable the liquid charge to be self propelling, or semi-self propelling. Various propellant devices can be incorporated into the closing device. These devices can be self triggered, or triggered by the fire fighting device 10. A propellant device can have a variety of explosive devices, including an explosive device similar to a typical bullet, having a propellant, a primer and a casing. This explosive device can launch the liquid charge by disengaging a case or shell, or by launching the explosive device along with the liquid charge, in a rocket-like manner. Similarly, the propellant device can launch the non-rigid encapsulation by expelling a portion of the liquid charge 25 contained within the encapsulation from the tail of the liquid charge. Other propellant devices and combinations thereof can be incorporated as will be practical with the invention.

In another aspect of the invention, a liquid charge can include a disruption apparatus that disrupts the flight integrity component of the liquid charge during flight. As described above, it has been recognized that it is often desirable to fight a fire with a spray of liquid, as a sprayed or diffused liquid can vaporize more quickly than a solid liquid charge and the liquid vapor can be used to asphyxiate a fire. Thus, various forms of disruption apparatuses can be used with the present invention to rip, tear, disassemble, or explode the encapsulation. The disruption apparatus can be triggered by proximity to the heat or light from the fire, or configured with a time delay to disrupt the flight integrity component after entry into a fire zone. Alternatively, the encapsulation can be configured to release the liquid charge in response to direct contact with the heat of the fire. For instance, the flame or heat source may either melt or combust the encapsulation, or may also initiate a chemical reaction in the encapsulation material that causes it to act in a desirable way, such as develop a hole that preferentially squirts the contents in a given direction, or to created rents in the layer to facilitate dispersion.

In the embodiment shown, the flight integrity component in the form of a non-rigid encapsulation 19 can comprise a disruption apparatus (shown generally as disruption apparatus 23) that is configured or adapted to disrupt the non-rigid encapsulation and to facilitate the dispersion of or diffuse the liquid charge. The disruption apparatus can function to breach or break open the encapsulation, or otherwise facilitate the dispersion of the liquid charge. The disruption apparatus may be used to control the timing of the dispersion of the liquid charge (e.g., delayed or upon impact or during flight), the direction of the dispersion of the liquid charge (e.g., forward dispersion), etc. Essentially, the disruption apparatus helps to prevent the unwanted situation where the encapsulation remains intact (the liquid charge is not dispersed) after being launched, and therefore ineffective for its intended purpose.

The disruption apparatus may comprise any system or device capable of breaching or otherwise breaking open the encapsulation 19. The disruption apparatus may be configured to operate with the encapsulation 19 or the closing device 22, or both. The disruption apparatus may be configured to be activated during flight of the encapsulation (e.g., an airborne dispersant), or it may be activated upon or at some point after impact. The disruption apparatus may comprise mechanical, electrical, electromechanical systems. For example, the disruption apparatus can comprise an explosive device or charge supported somewhere on the encapsulation or the closing device. In another example, the disruption apparatus may comprise an mechanical device that impales or otherwise breaches a portion of the encapsulation. One skilled in the art will recognize other objects or devices or systems capable of performing the breaching function.

The disruption apparatus may be activated in a number of ways. For example, the disruption apparatus may be operable with a trigger of some sort. The trigger may comprise a real-time operator-initiated trigger, wherein the operator selectively triggers or activates a delayed disruption of the encapsulation and the diffusing of the liquid charge at a time judged to be most appropriate or effective. Alternatively, the trigger may comprise a programmed trigger, such as a preprogrammed trigger that reflects actual conditions or variables to be encountered. In still another embodiment, the encapsulation or closing device may support a spool of wire (e.g., for receiving electrical signals that activate an associated disruption apparatus) or string (for activating a mechanical disruption apparatus) that is spooled upon launch.

Rheologically modified fluids can also be combined with the non-rigid flight integrity component (e.g., additive, non-rigid encapsulation component) to allow for solid substances to be entrained in the liquid charge. For example, 0.10% (w) Carbopol® 674 (a product of Noveon) can be combined with a liquid charge to entrain or suspend sand particles within the liquid charge. In this manner, a variety of solids can be entrained in a liquid charge and launched. These solids can be capsules of paint, sand, pellets, explosive charges, and other solids that will be practical to the invention. In one aspect, the rheologically modified fluids can function as a flight integrity component to increase the cohesive properties of the liquid projectile in flight. In another aspect, the rheologically modified fluids can provide additional mass to increase the impact force applied to the target, as well as a delivery system that transports the solids to the target.

Liquid charges 25 and liquid charges combined with additives, as previously described, can be used to fill the encapsulation 19. A variety of other liquids, chemicals, and other substances can be combined with the liquid charge in the non-rigid encapsulation.

In one aspect of the invention, a liquid charge 25 combined with a fire retardant can be used to fill the encapsulation 19. The encapsulation can contain the liquid charges and fire retardant that is selected to suit the particular fire.

In another aspect of the invention, the fire retardant can be a liquid, solid, or gas that creates an oxygen depletion region in or near a target location. For instance, the fire retardant can be liquefied carbon dioxide, liquefied nitrogen or other non-flammable gas cooled and/or compressed to its liquid phase, etc.

In another aspect of the invention, foam-producing chemicals or agents can be combined with a liquid charge within an encapsulation. When the foam-producing liquid charge is released from the encapsulation it can create a fire-blanketing foam which is used to extinguish fires in combustible liquids, such as oils and tar. These foaming additives can be capable of expanding the volume of foam several hundred times.

In another aspect of the invention the flight integrity component can comprise an electro-rheo logical fluid or a magneto-rheological fluid, in which the fluid properties can be modified in a controlled manner by the application of an electrical charge or magnetic field to the fluid, in combination with electronic hardware 21 and an energy source 29 that can provide the electrical charge or magnetic field. The electronic hardware and the energy source can be incorporated into the non-rigid encapsulation, such as the closing device 22, and can apply the electrical charge or magnet field to the liquid charge before, during and after the launching of the liquid charge to create and maintain the non-rigid encapsulation for the launch and duration of the flight. The electronic hardware can also be configured to discontinue the electrical charge or magnetic field at the appropriate time to disrupt the non-rigid encapsulation and release the liquid charge as a spray.

In another aspect of the invention the encapsulation 20 or closing device 22 can include one or more sensors 112 for analyzing the fire in mid-flight to determine an appropriate localized target portion. The encapsulation 20 or closing device 22 can also be configured with communication devices 122 for relaying this information back to the user of the fire fighting device to enable the firefighter to place the next shell more accurately on target, such as at the base of the fire.

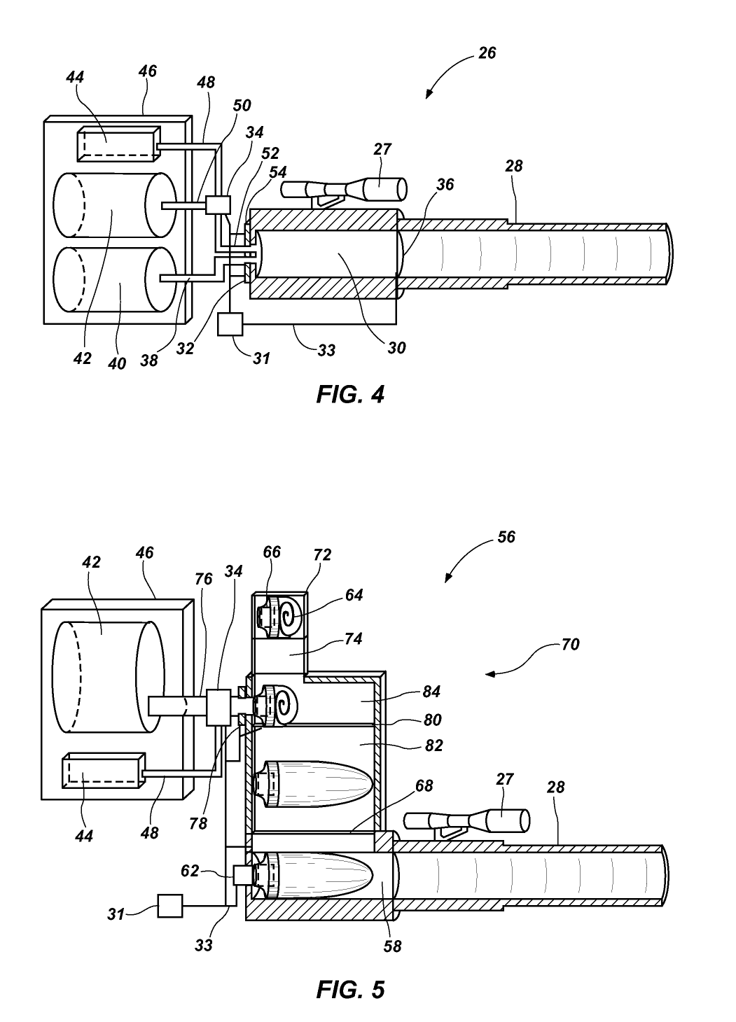

As shown in FIG. 4, a firefighting device 26 in an example implementation in accordance with the invention includes at least a barrel 28, a chamber 30, a sighting structure 27, a launching system (comprising the pressurized gas source 40, launching valve 32, and gas connection line 38), and a charge modification component 34. The barrel is joined to the chamber at one end, and directs a liquid charge in a direct path down and out the opposite end. A liquid charge is formed in the chamber. The chamber includes a liquid inlet 54 valve, a launching valve 32, and a chamber release valve 36. The modified liquid enters the chamber from the liquid inlet, and is enclosed by the closure release mechanism 36. When the chamber is filled with the modified liquid, forming a liquid charge, the liquid inlet valve can be closed and the launching valve opened. The launching valve can release the pressurized gas into the chamber, via a gas connection line, increasing the pressure behind the charge. As the launching valve opens the chamber release valve can also be opened, allowing the pressurized gas to launch the liquid charge down and out the barrel. The valves can be selected from variety of valves practical to the invention, including solenoid valves and fast-acting diaphragm valves or poppet valves, etc.

The modified liquid can enter the chamber from a charge modification component 34, which can combine the liquid from a liquid source 42 with a flight integrity component from a flight integrity component source 44. The charge modification device can receive the flight integrity component via a flight integrity component source connection 48. The charge modification component prepares the liquid to resist substantial break-up during launch. The charge modification component can be a relatively simple device that mixes or stirs a liquid with a predefined proportion of an additive or it can be a multi-process device that modifies temperatures, has various combination methods, modifies pressure, or any combination of these functions. The modified liquid can be directed to the inlet valve 54 via a modified liquid connection line 52.

A sighting structure 27 can be coupled to the barrel 28 for identifying and targeting a target location. The sighting structure employed in the present invention includes a wide variety of sighting structures. Typical sighting structures can include a laser sight, an infra-red targeting system, optic sights, dot sights, ring sights, peep sights, a scope, and the like. Alternatively, a sighting structure can include a camera, or an electronic or electromechanical device that provides targeting capabilities to a user, or any combination of sighting structures. For example, a pilot flying a helicopter or plane which is configured with a fire fighting device, according to the present invention, can have a targeting panel which allows him to target the fire fighting device via an electrical panel or an electromechanical apparatus. In this manner the sighting structure is coupled to the barrel via electronic sensors, controllers, or the like.

In many situations, it may be desirable to launch a liquid charge into a target location within a fire, such as the seat of the fire or a particular hot spot within a fire. Alternatively, a target location can also be outside a fire, such as in a neighboring room or a ceiling. When fighting a forest fire a target location may be a nearby location which could be doused to create a firebreak. Targeting involves configuring the positioning features of the firefighting device to direct the barrel so as to position the target within the trajectory of the launched liquid charge. Because firefighting techniques require analysis of the fire, followed by coordination and precision of fire fighting efforts, a precise sighting structure can enhance a fire fighters ability to identify and target specific locations within or around a fire.

A controller 31 or combination of multiple controllers can be incorporated into the fire fighting device 26 to act as a sequencer by controlling and synchronizing the function of the launching valve 32, the chamber release valve 36, and the inlet valve 54. By controlling the charge modification component 34, the chamber release valve, and the inlet valve, a controller can act as a loader. A controller implementation can be a mechanical or an electric controller for sequentially opening and closing valves, as shown by electrical wire connections 33.

In one aspect of the invention, the flight integrity component source 44, liquid source 42, and the gas source 40, can be contained or carried in a source transport system 46. This transport system may be a fire engine (as shown in FIG. 1), aerial tanker, backpack device, or other transport systems that will be practical to the invention. The liquid source can be a fresh water source or salt water source, a fire hydrant or other water source, a tank of pressurized or non-pressurized liquid, or another liquid source that will be practical with the invention.

As shown in FIG. 5, a fire fighting device 56 in one aspect of the invention includes at least a barrel 28, a launching chamber 58, and a launching system (comprising the triggering device 62 and the propulsion device 66), and a charge modification component (comprising the charge modification chamber 84, the inlet valve 78, the charge modification component chamber closure 80, and the encapsulation loader 74), loader 68, and sequencer 70. The fire fighting device modifies a liquid charge by enclosing the liquid in a non-rigid encapsulation 64, the function of which was previously described. The non-rigid encapsulation can have a collapsible plastic encapsulation being rolled from one end onto itself, or have an alternate unfilled configuration. The encapsulation loader, being configured to relocate an encapsulation from the encapsulation source to the charge modification device, loads an empty encapsulation from the encapsulation source 72 into the charge modification device, where it is filled with a liquid. This loading process can be accomplished by means of a moving wall, which allows the encapsulation to fall into place, or other methods that will be practical to the invention.

The non-rigid encapsulation 64 can be filled with liquid from a liquid source 42 loaded via a liquid connection line 76 and an inlet valve 78 by the charge modification component. As liquid enters the non-rigid encapsulation the collapsible plastic encapsulation can begin to un-pack, unroll, unfold, or decompress as it expands to the pressure of the liquid. The charge modification chamber 84 is configured to suit the particular encapsulation expanding method or plurality of methods. When the encapsulation is filled with liquid the inlet valve is closed and a closing device 22 (as previously described) is fixed to enclose the liquid inside the collapsible plastic encapsulation. The filled encapsulation now forms a liquid charge and can be moved to the loading chamber 82. The loading chamber can configured to hold multiple filled encapsulations or it can be configured to hold a single, filled encapsulation. The loading chamber can be an enclosed structure, with an opening for a loader, or a chamber, combined with a breech for alternative back loading. Once the liquid charge is in the loading chamber, the loader 68 can load it into the launching chamber 58. The loader can be a simple movable wall for mechanically positioning the liquid charge in position for launching in the launching chamber, or a more complex loading mechanism, as will be practical to the invention.

In another aspect of the invention, a filled encapsulation can be transferred directly from the charge modification chamber 84 into the launching chamber. In yet another aspect of the invention, the charge modification chamber can be incorporated into the launching chamber, so as to eliminate transportation of the filled encapsulation. The incorporation of these two components will be apparent to one of ordinary skill in the art.

Once a liquid charge is loaded into the launching chamber and the chamber is closed, the triggering device 62 can trigger the propellant device 66 of the non-rigid encapsulation, launching the liquid charge down the barrel 28. The propellant device can incorporate a variety of devices, as previously described. Subsequently, the triggering device can incorporate a variety of devices to suit the respective propellant device, as will be practical to the invention. A propellant device can be integrally joined to the non-rigid encapsulation, or can become disengaged upon ignition of the propellant device. Alternatively, the triggering device can trigger a separate explosive device (not shown) within the launching chamber that will launch the liquid charge down and out the barrel.

The encapsulation source 72, encapsulation loader 74, charge modification component, and loading chamber 82 can combine to form a sequencer 70. The sequencer enables sequential launching capabilities by providing a continuous supply of liquid charges to the loader 68 for being loaded into the launching chamber 58. In this manner, a plurality of liquid charges can be fired in succession, as illustrated in FIG. 1. However, launching the projectiles in succession may not always be desirable. It is contemplated that a plurality of liquid charges that are intended to mix at the target site may be launched from different launching devices, wherein strategic timing and placement of the various liquid charges may be of concern and therefore specifically controlled. The sequencer can enable sequential launching of a plurality of projectiles to cause these to mix at the target site, whereupon mixing a functional attribute is obtained.

In one aspect of the invention, a controller 31 or combination of multiple controllers can be incorporated into the fire fighting device 26 to aid the sequencer by controlling and synchronizing the various components of the sequencer. A controller can be comprised of, a mechanical or electric controller for sequentially opening and closing valves, as shown by controller connections 33.

In another aspect of the invention, a charge of liquid received from the liquid source 42 can be combined in the charge modification component 34 with a flight integrity component from a flight integrity component source 44, as previously described, before the liquid is inserted into the non-rigid encapsulation 62. The flight integrity component source can be connected to the charge modification component via a flight liquid modification source connection 48. The flight integrity component can be a variety of additives, liquids, chemicals and other substances that can be inserted into a non-rigid encapsulation, as previously described. For example, a liquid for creating an oxygen depletion region can be added into a liquid and loaded into a non-rigid encapsulation, for launch.

Additionally, the charge modification component 34 can be fluidly coupled to multiple liquid sources 42 and multiple flight integrity component sources 44, to provide a plurality of liquid projectiles that include two or more different types of fluids and/or entrained solids, and which can be sequenced and launched consecutively one after the other so that the two or more liquids, with/or without entrained solids, mix and react at the impact site to accomplish a desired effect that would not be possible or practical with a single component by itself.

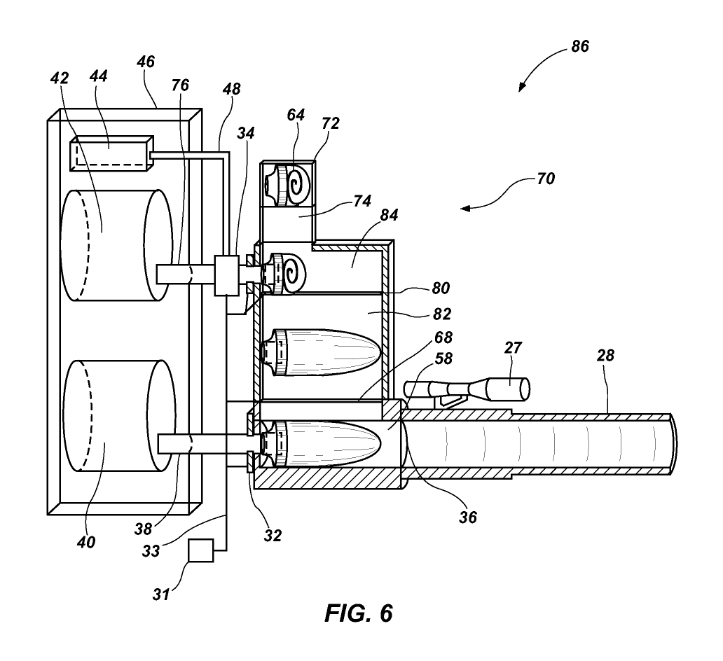

As shown in FIG. 6, a fire fighting device 86 according to one aspect of the invention is similar in parts and function to the fire fighting device 56 of FIG. 5, except that it contains a launching system that uses pressurized gas (comprising a gas source 40, a gas source connecting line 38, and a launching valve 32) similar to that of FIG. 4. The description above relating to FIGS. 4 and 5 is incorporated herein where appropriate. Once a liquid charge is in the launching chamber 58 of the fire fighting device, the launching valve can be opened, pressurizing the area behind the liquid charge, forcing the liquid charge down and out the barrel. As illustrated, a chamber release valve 36 can be incorporated with the launching chamber to allow for an increase in pressure build-up before launch.

In another aspect of the present invention the launching device can include multiple dual-purpose charge modification/launching chambers arranged in a circular pattern or cartridge that is rotatable about a central axis offset from the longitudinal axis of the barrel 28. As can be appreciated, sequentially rotating the dual-purpose chambers into alignment with the barrel 28 of the launching device can allow for the sequential launching of multiple liquid charges, much like a Gatling Gun. The rotating cartridge can further be configured as a rotating sequencer, complete with an encapsulation source, an encapsulation loader, and a charge modification component, that can fill and prepare an encapsulation in each dual purpose chamber for launching as the cartridge rotates the chamber towards the barrel of the launching device. Once the dual-purpose chamber is aligned with the barrel, the launching device can use either the explosive propellant device 66 of FIG. 5 or the compress gas source 40 of FIG. 6 to launch the liquid charge.

It is also contemplated that the non-rigid encapsulation used in each of the above described launching devices can be pre-filled and a projectile pre-formed and subsequently loaded into the launching device.

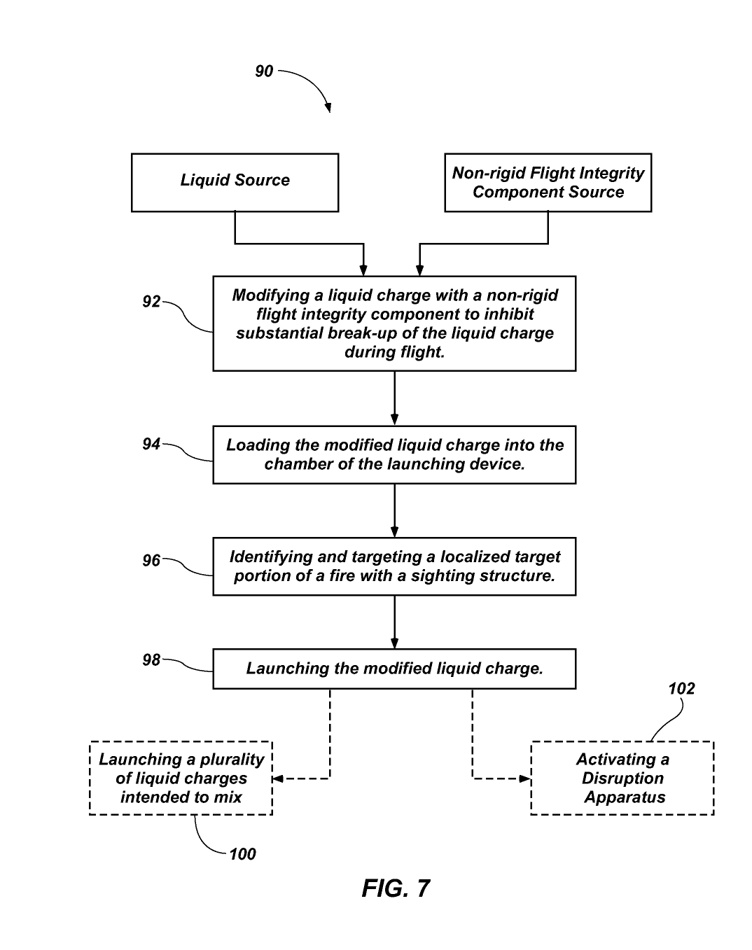

Illustrated in FIG. 7 is method 90 for utilizing a modified liquid charge in a fire fighting device, in accordance with a representative embodiment of the present invention. The method 90 includes modifying 92 a charge of liquid from a liquid source with a non-rigid flight integrity component to inhibit substantial break-up of the liquid charge during flight. The non-rigid flight integrity component can comprise a variety of components, as previously mentioned. In one aspect the flight integrity component is an additive, and modifying 92 can comprise mixing the liquid charge with the additive to increase the viscosity and/or cohesiveness of the liquid charge in response to shear forces, and/or to reduce the friction and drag of the liquid charge. In another aspect the flight integrity component is a non-rigid encapsulation, such as a collapsible plastic encapsulation, and modifying 92 includes encapsulating the liquid charge within the encapsulation.

The method 90 also includes loading 94 the modified liquid charge into a chamber. In cases where the flight integrity component is a non-rigid encapsulation, loading 94 further comprises loading the filled encapsulation into the chamber. In cases where the flight integrity component is an additive, loading 94 further comprises loading the liquid/additive mixture into the chamber.

The method 90 further includes identifying 96 and targeting a localized target portion of a fire with a sighting structure. The target location can be within a fire, such as the seat of the fire or a particular hot spot. The target location can also be outside a fire, such as a smoky location, a nearby room, a ceiling, or a nearby location which could be doused to create a firebreak. Targeting further includes configuring the positioning features of the firefighting device to direct the barrel so as to position the target within the trajectory of the launched liquid charge.

The method 90 further includes launching 98 the modified liquid charge from the fire fighting device. Launching 98 can include discharging the liquid charge with pressurized gas. This step can also comprise, discharging the liquid charge with an explosive device. This step can also comprise, triggering a launch. When triggering a launch, the liquid projection fire fighting device is triggering the launch of the liquid charge, wherein the liquid charge comprises a fire fighting device.

The method may, optionally, further comprise activating 102 a disruption apparatus to effectively breach the liquid projectile to facilitate the dispersion of the liquid charge once launched.

In yet another aspect of the present invention, the method for utilizing a liquid charge in a in a fire fighting device may further comprise sequentially launching the liquid charges. The step of sequencing the liquid charges comprises, organizing the modifying 92, loading 94, identifying and targeting 96, and launching 98 steps, and repeating the steps (with a single or multiple launching devices) in order to launch a plurality of liquid projectiles.

In yet another aspect of the present invention, the method for utilizing a liquid charge in a liquid projectile launching device can further comprise launching 100 a plurality of projectiles at fire to effectuate useful mixing of the contents present in the individual projectiles. The idea behind sequential launching is that at least two of the plurality of sequentially launched projectiles can be comprised of contents that, when unmixed, are relatively inert, but that when mixed together possess a functional attribute. Functional attributes may include exploding, corroding, freezing, fouling with fibers or high viscosity fluid, creating an oxygen-depletion zone, creating a cloud that reduces visibility, etc. The step of sequencing comprises organizing the modifying, loading, and launching steps, and repeating the steps in the desired sequence to sequentially launch the plurality of liquid projectiles.

The foregoing detailed description describes the invention with reference to specific representative embodiments. However, it will be appreciated that various modifications and changes can be made without departing from the scope of the present invention as set forth in the appended claims. The detailed description and accompanying drawings are to be regarded as illustrative, rather than restrictive, and any such modifications or changes are intended to fall within the scope of the present invention as described and set forth herein.

More specifically, while illustrative representative embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, any steps recited in any method or process claims, furthermore, may be executed in any order and are not limited to the order presented in the claims. The term “preferably” is also non-exclusive where it is intended to mean “preferably, but not limited to.” Accordingly, the scope of the invention should be determined solely by the appended claims and their legal equivalents, rather than by the descriptions and examples given above.

1. A fire fighting device for launching a liquid charge at a localized target portion of a fire, the fire fighting device comprising:
a liquid charge modified with a flight integrity component to inhibit substantial break-up of the liquid charge during flight;
a barrel for directing the modified liquid charge at a target having a chamber at one end and being open at the opposite end;
a sighting structure coupled to the barrel for identifying and targeting a localized target portion of a fire; and
a launching system for launching the modified liquid out of the barrel.

2. The fire fighting device of claim 1, further comprising a loader for loading the flight integrity component.

3. The fire fighting device of claim 1, wherein the launching system comprises a supply of pressurized fluid.

4. The fire fighting device of claim 1, wherein the launching system comprises an explosive device positioned behind the liquid charge within the barrel.

5. A modified liquid charge for being projected from a fire fighting device towards a localized target portion of a fire, the modified liquid charge comprising:
a liquid charge for being projected from a fire fighting device towards a localized target portion of a fire; and
a non-rigid flight integrity component combined with the liquid charge to inhibit substantial break-up of the liquid charge during flight.

6. The liquid charge of claim 5, wherein the flight integrity component is an additive.

7. The liquid charge of claim 6, wherein the additive includes a cohesiveness-increasing component that increases liquid cohesiveness, wherein the cohesiveness-increasing component is selected from the group consisting of polyethylene oxide, polyacrylamide, polypropylene oxide, polydiamine, and combinations or mixtures thereof.

8. The liquid charge of claim 6, wherein the additive includes a viscosity-increasing component that increases the viscosity of the liquid charge in response to shear force.

9. The liquid charge of claim 6, wherein the additive is selected from a group consisting of polyethylene glycol with nano particles of silica; corn starch; potato starch; pectin; xanthan gum; arrow root powder; dihydroxyproprl ethers of cellulose; cellulose-free xanthan gum with a number of cellulose compounds, including carboxymethyl cellulose, hydroxyethyl cellulose, and hydroxypropylmethyl; sulfonated guar and hydropropyl guar or derivatives; sulfonated guar and hydroxyelthyl cellulose or derivatives; cationic guar and hydroxypropyl guar or derivatives; cationic guar and hydroxyethyl cellulose or derivatives; hydroxylpropyl cellulose with polymaleic and hydroxyl derivatives; and polyethylene oxide; or combinations or mixtures thereof.

10. The liquid charge of claim 6, wherein the additive comprises a shear-thickening component adapted to increase the viscosity of the liquid charge with increasing shear stress applied thereto.

11. The liquid charge of claim 6, wherein the additive comprises a rheologically modified fluid.

12. The liquid charge of claim 6, wherein the additive comprises an electro-rheological fluid.

13. The liquid charge of claim 6, wherein the additive comprises a magneto-rheological fluid.

14. The liquid charge of claim 5, wherein the liquid charge comprises a rheologically modified fluid.

15. The liquid charge of claim 5, wherein the liquid charge comprises an electro-rheological fluid.

16. The liquid charge of claim 5, wherein the liquid charge comprises a magneto-rheological fluid.

17. The liquid charge of claim 5, wherein the non-rigid flight integrity component comprises a rheo logically modified fluid

18. The liquid charge of claim 5, wherein the non-rigid flight integrity component comprises an electro-rheological fluid.

19. The liquid charge of claim 5, wherein the non-rigid flight integrity component comprises a magneto-rheological fluid.

20. The liquid charge of claim 5, wherein the flight integrity component is a non-rigid encapsulation.

21. The liquid charge of claim 20, wherein the non-rigid encapsulation comprises a collapsible plastic encapsulation.

22. The liquid charge of claim 20, wherein the non-rigid encapsulation comprises a disruption apparatus adapted to breach the non-rigid encapsulation and facilitating the diffusing of the liquid charge.

23. The liquid charge of claim 20, wherein the disruption apparatus is operable with a trigger that triggers a delayed breach of the non-rigid encapsulation and the diffusing of the liquid charge.

24. The liquid charge of claim 20, wherein the non-rigid encapsulation further comprises a closing device having propellant device affixed thereto.

25. The liquid charge of claim 5, wherein the liquid charge contains entrained solids for delivering the entrained solids against the target.

26. The non-rigid encapsulation of claim 5, wherein the liquid charge includes a fire retardant.

27. The non-rigid encapsulation of claim 26, wherein the fire retardant comprises an oxygen-depleting fire retardant selected from a group consisting of liquefied carbon dioxide and liquefied nitrogen.

28. A method for utilizing a modified liquid charge in a fire fighting device to engage a localized target portion of a fire, the method comprising:
modifying a liquid charge with a non-rigid flight integrity component to inhibit substantial break-up of the liquid charge during flight;
loading the modified liquid charge into a chamber;
identifying and targeting a localized target portion of a fire via a sighting structure attached to a barrel; and
launching the modified liquid charge from the barrel towards the target.

29. The method of claim 28, wherein the modifying the liquid charge comprises mixing the flight integrity component with the liquid charge before launch.

30. The method of claim 29, wherein the mixing the flight integrity component with the liquid charge comprises increasing the cohesiveness of the liquid charge.

31. The method of claim 28, wherein the modifying the liquid charge comprises encapsulating the liquid charge within a flexible container.

32. The method of claim 28, further comprising sequencing the liquid charges to enabling sequential launching capabilities.

33. The method of claim 28, wherein the launching the modified liquid charge comprises discharging the modified liquid charge with pressurized gas.

34. The method of claim 28, further comprising launching a plurality of liquid charge in a sequence to effectuate useful mixing of contents of individual liquid charges at a target site, wherein at least two of the plurality of sequentially launched liquid charges are comprised of contents that, when unmixed, are relatively inert, but that when mixed together possess a functional fire suppressant attribute.

35. The method of claim 28, further comprising disrupting the non-rigid flight integrity component with a disruption apparatus to release the liquid charge as a spray.

36. The method of claim 28, further comprising triggering the disruption apparatus by proximity to the heat or light from the fire.

37. The method of claim 28, further comprising delaying the triggering the disruption apparatus until after entry of the modified fire-suppressing liquid charge into a fire zone.

38. A method for introducing a fire-suppressing liquid charge to a localized target portion of a fire, the method comprising:
combining a liquid charge with at least one fire-suppressing component to form a fire-suppressing liquid charge;
modifying the fire-suppressing liquid charge with a non-rigid flight integrity component to inhibit substantial break-up of the liquid charge during flight;
loading the modified fire-suppressing liquid charge into a chamber;
identifying and targeting a localized target portion of a fire via a sighting structure attached to a barrel; and
launching the modified fire-suppressing liquid charge from the barrel towards the target portion of the fire.
